(19) United States
(12) Patent Application Publication
(10) Pub. No.: US 2018/0065205 A1
(43) Pub. Date: Mar. 8, 2018

(54) METHOD FOR PRODUCING A CAMSHAFT

(71) Applicant: Mahle International GmbH, Stuttgart (DE)

(72) Inventors: Andreas Geyer, Wendlingen (DE); Mario Mohler, Stuttgart (DE); Peter Winkler, Stuttgart (DE)

(21) Appl. No.: 15/697,431

(22) Filed: Sep. 6, 2017

(30) Foreign Application Priority Data
Sep. 7, 2016 (DE) DE102016217024.4

(51) Int. Cl. B23K 13/02; C21D 9/30; B23K 20/12; C21D 1/42

(52) U.S. Cl. CPC B23K 13/025; C21D 9/30; B23K 2201/005; C21D 1/42; B23K 20/129; B23K 20/12

(57) ABSTRACT

A method for producing a camshaft may include: providing at least two metallic components; and welding the at least two components to one another via a combined induction/friction welding method. According to an implementation, one of the at least two components is a camshaft tube and the other of the at least two components is a drive element.

### CROSS-REFERENCE TO RELATED APPLICATION

This application claims priority to German Patent Application No. 10 2016 217 024.4, filed on Sep. 7, 2016, the contents of which are hereby incorporated by reference in its entirety.

### TECHNICAL FIELD

The invention at hand relates to a method for producing a camshaft. The invention furthermore relates to a camshaft produced according to this method.

### BACKGROUND

When welding drive elements to camshaft tubes, a friction welding method is typically used, which, however, can lead to unwanted welding beads, which necessitate a post-processing. There are many variations of friction welding methods, but they are all based on the same principle, namely that dynamic friction is used in order to convert kinetic energy (commonly rotational movement) into heat. None of the metals is melted at any time during the process, which is why this process falls under the category, which is known as solid state welding. Due to the fact that a liquefying does not occur, these welding processes are resistant to fusion welding defects, such as porosity, slag inclusions, incomplete fusion, insufficient penetration, undercuts, etc.

A solid state welding method for pipelines is known from DE 699 20 770 T2, which combines the respective advantages of induction welding and friction welding.

A welding of two piston parts is known for example from U.S. Pat. No. 7,005,620 B2.

### SUMMARY

The invention at hand deals with the problem of specifying an improved or at least an alternative embodiment, which overcomes in particular the disadvantages known from the prior art, for a production method of a camshaft of the generic type.

According to the invention, this problem is solved by means of the subject matter of the independent claim(s). Advantageous embodiments are the subject matter of the dependent claims.

The invention at hand is based on the general idea of using a combined induction/friction welding method for the first time in a production method of a camshaft comprising at least two metallic components, in order to connect the metallic components of the camshaft to one another. In particular the welding beads, which typically appear in response to the friction welding, can thus be avoided, whereby the post-processing effort resulting therefrom can at least be reduced as well. In addition, the combined induction/friction welding method according to the invention provides the large advantage that, compared to the laser welding, the material selection is not limited to such a large extent.

In the case of an advantageous further development of the invention, a camshaft tube and a drive element, which is arranged on the longitudinal end thereof, are used as components. The method according to the invention thus provides for a quick, cost-efficient and simultaneously high-quality production of camshafts for the first time.

In an advantageous further development of the invention, the combined induction/friction welding method comprises the steps of:
heating opposite, in particular parallel surfaces of the components by means of an induction heater, in particular by means of a high frequency induction heater, to a first temperature, which is generally above the re-crystallization point of the components in a non-oxidizing atmosphere, in that the induction heater is arranged between the opposite surfaces or on the outside,
continuously moving at least one component relative to the other component parallel to the opposite flat and parallel surfaces,
bringing together the opposite surfaces of the components, which are to be connected to one another, with an axial force, while at least one of the components is still moved, in order to weld the opposite surfaces of the components to one another, wherein at least approximately 90% of the welding energy is contributed by the induction heater and the equalizing welding energy is contributed by common friction welding, and wherein a loss of total length of the components as a result of squeezing is less than 1.0 axial millimeters per millimeter of the wall thickness of the components.

In the alternative, it is also conceivable to apply the induction heater on the outside, so that it encompasses the opposite surfaces, which are to be welded to one another, or surrounds them in a ring-shaped manner, respectively.

The method according to the invention thus comprises a quick heating of the opposite surfaces of the components by means of an induction heater and further a continuous moving of at least one of the components relative to the other component parallel to the opposite planar surfaces, such as, e.g. by rotating one of the components. Finally, the welding method, which is now used for the first time for producing camshafts, comprises a quick bringing together of the opposite component surfaces by means of an axial force, which is significantly lower than the compressing force in response to the common friction welding, while the one component is still moved relative to the other component, in order to solid state weld the opposite surfaces of the components.

In the case of an advantageous further development of the method according to the invention, the latter comprises a heating of the opposite surfaces of the components, which are to be welded, to the hot work temperature by means of an induction heater in less than 30 seconds, in order to limit the heating of the component to the first 1.5 mm or less of the opposite surfaces of the components, which are to be welded. The frequency of the induction heater is preferably 3 kHz or more and more preferably approximately 25 kHz or more.

In the preferred solid state welding method of this invention, the components can be welded to one another in approximately one second, following the heating, wherein the axial force is maintained for approximately five additional seconds. The solid state welding of this invention is thus quicker and much more efficient than friction welding or induction heating and produces reproducible welded connections comprising a high integrity at very low rotational speeds.

In the case of a further preferred embodiment of the invention, the heating and welding steps are carried out in a non-oxidizing atmosphere by flooding the components with a non-oxidizing gas, such as nitrogen, e.g., which significantly improves the resulting welded connection.

As specified above, the improved solid state welding method according to the invention produces an improved welded connection with significant reduction of a loss flash. Where tube-like components are welded to one another by means of common friction welding, the large internal flash, which is produced by means of common friction welding, can also impact the flow of fluids through the components. This invention thus comprises a component, such as, e.g. a camshaft tube and a drive element, comprising opposite planar surfaces, which are welded to one another, comprising a relatively small planar flash, which extends radially from the contact plane of the opposite planar welded surfaces. The flash volume corresponds to a combined loss of length of less than 1.0 axial millimeters per mm of wall thickness. In particular an oil flow can thus be flow-optimized inside the camshaft, for example for lubricating bearing points.

The method of this invention preferably also comprises the enclosing of the welding area and insertion of a protective gas around the surfaces. As specified above, the heating and welding steps are preferably carried out in a non-reactive atmosphere, in order to avoid chemical reaction of the heated abutting surfaces with any of the gases, which are typically present in the earth's atmosphere: Oxygen, nitrogen, carbon dioxide, water vapor, etc., e.g., steel quickly connects to oxygen at elevated temperatures, whereby oxides are produced, which produce defects in the welded connection. Vice versa, nitrogen reacts only slowly with steel and is thus a very useful protective gas. It goes without saying that other protective gases are also conceivable, such as, for example, argon or helium.

In the alternative, harmful gases in the atmosphere can be ruled out for all types of metals by carrying out this solid state welding method in a vacuum. For special metals, harmful gases can be ruled out by precoating the opposite surfaces with a very thin layer of a metallurgically compatible solid barrier substance, which will also not react with the normal components of the earth's atmosphere.

Even though argon is the most logical selection of a protective gas, experimentation has shown that argon causes flashovers in the vicinity of the end of the heating cycle, which can be avoided by using nitrogen.

When the temperature of metals is increased, the mechanical properties thereof gradually become less elastic (and brittle) and more malleable (and viscous), until the melting point is reached, at which any mechanical stability has been lost. The yield strength also decreases as temperatures increase. A material-specific temperature is generally identified as the hot work temperature (THW), which is generally identified as a temperature above the re-crystallization point or as a temperature, which is high enough to avoid cold work hardening. It is assumed that THW for a given metal has every temperature between approximately 50% and 90% of the melting temperature, expressed in absolute terms (i.e. Kelvin or degrees Rankine). Common friction welding uses mechanical friction in order to increase the temperature of two adjoining components to THW, whereby the gliding movement can cause a controlled level of connection between the two components, which results in a strong welded connection. The solid state welding method of this invention uses induction heating in order to increase the abutting surfaces of the components to the hot work temperature.

The method of this invention can be carried out on the basis of any type of friction welding, including flywheel, continuous, orbital and oscillating friction welding.

Further important features and advantages of the invention follow from the subclaims, form the drawings and from the corresponding figure description by means of the drawings.

It goes without saying that the above-mentioned features and the features, which will be discussed below, cannot only be used in the respectively specified combination, but also in other combinations or alone, without leaving the scope of the invention at hand.

Preferred exemplary embodiments of the invention are illustrated in the drawings and will be discussed in detail in the following description, whereby the same reference numerals refer to the same or to similar or functionally identical components.

### BRIEF DESCRIPTION OF THE DRAWINGS

In each case schematically:

FIG. 1A shows a partial longitudinal section of a camshaft, which is welded according to a common friction welding method;

FIG. 1B shows a partial side cross sectional view of a camshaft, which is welded according to the solid state welding method of the invention;

FIG. 1C shows a partial longitudinal section of a second embodiment according to a camshaft, which is welded according to the solid state welding method of the invention,

FIG. 2A shows a longitudinal section of an area of the device for the solid state welding method,

FIG. 2B shows a sectional illustration along the sectional plane B-B,

FIG. 3 shows a camshaft, which is welded by means of the method according to the invention.

### DETAILED DESCRIPTION

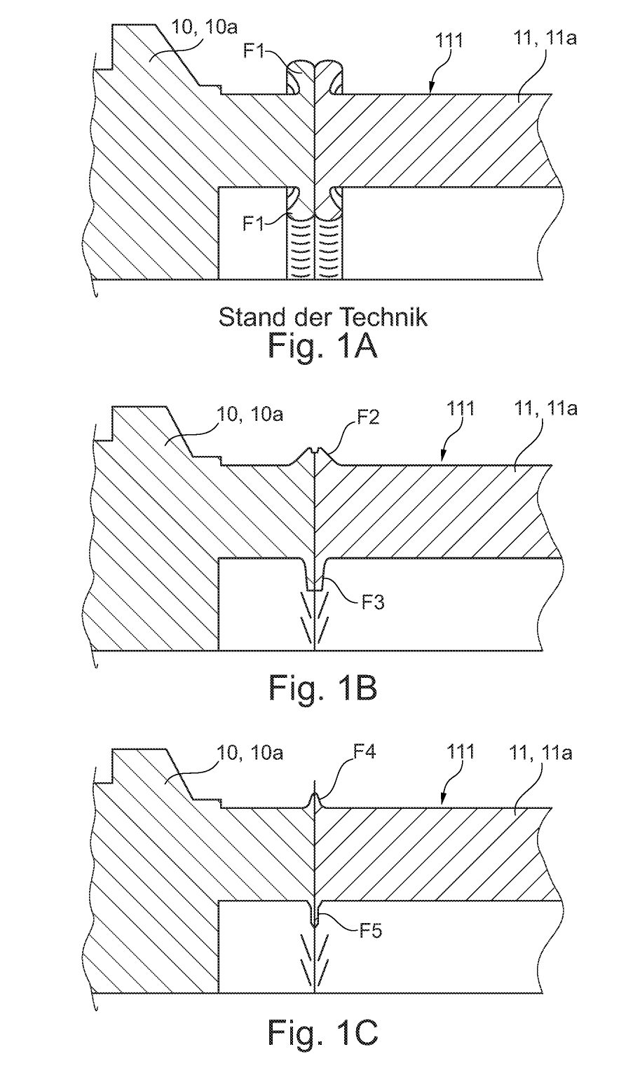

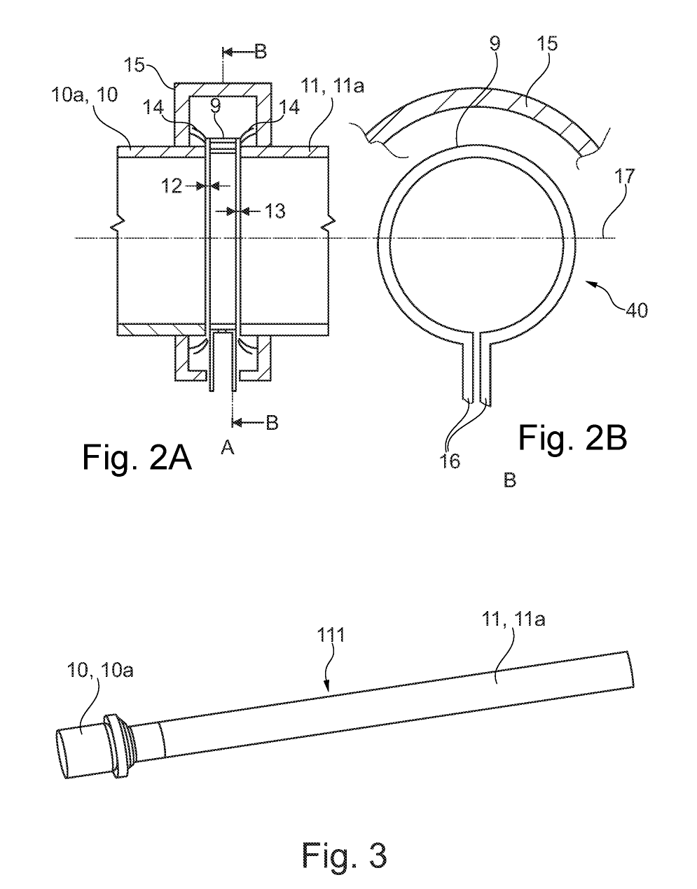

FIG. 1A illustrates a welded camshaft 111, which is produced according to common friction welding techniques, such as, e.g., common flywheel friction welding. The camshaft 111 thereby has a component 11, for example a camshaft tube, and a component 10, for example a drive element, which are welded to one another by means of friction welding by rotating one of the components 10, 11 relative to the other component 11, 10 by simultaneously pressing against one another. In response to the friction welding, the opposite surfaces heat to the hot work temperature. The excess welding burr material thereby forms the largest problem of such friction welded connections, both on the inner and on the outer sides of the welded connection, which has the appearance of a double torus.

In particular in the case of camshafts 111, this welding burr detail F1 must be removed, which is associated with additional effort or which is disadvantageous, respectively, with regard to notching effect, dirt trap or increased corrosion risk (inner side), respectively. As specified above, the large welding burr volume results from the loss of length in the welding interface as a deterioration of the welded connection strength due to concentration of non-metallic inclusions. The solid state welding method according to the invention thus does not only reduce the material loss and the length during the welding cycle, but also improves the structural integrity.

FIGS. 1B and 1C represent the characteristic profiles of welded connections established according to the method according to the invention.

In FIG. 1C, the induction coil 9 is dimensioned appropriately, which results in a completely connected outer welding burr F4. The total quantity of welding burr material F4 and F5 can also be reduced. The welding burr volume and the loss of length was reduced significantly in both embodiments illustrated in FIGS. 1B and 1C, and the integrity of the welded connection was improved.

The combined induction/friction welding method according to the invention thereby comprises the following steps:
heating opposite, in particular parallel surfaces of the components 10, 11, by means of an induction heater 40 to a first temperature, which is above the re-crystallization point of the components 10, 11 of a non-oxidizing atmosphere, in that the induction heater 40 is in particular arranged between the opposite surfaces,
continuously moving at least one component 10, 11 relative to the other component 10, 11 parallel to the opposite surfaces,
bringing together the opposite surfaces of the components 10, 11, which are to be connected to one another, with an axial force, while at least one of the components 10, 11 is still moved, in order to weld the opposite surfaces of the components 10, 11 to one another, wherein a portion, preferably at least approximately 90% of the welding energy, is contributed by the induction heater 40 and the equalizing welding energy is contributed by common friction welding, and wherein a loss of total length of the components 10, 11 is less than 1.0 axial millimeters per millimeter of the wall thickness of the components 10, 11.

It is a particular advantage of the production method according to the invention that only a fraction of the axial length is used, whereby a much smaller volume of welded connection burr is generated. In contrast to the previous friction welding methods, the welding method according to the invention does in fact start before the two matching components come into contact. The induction heating phase, which provides the majority of the required welding energy, runs together with the acceleration of the rotating component 10, 11 and ends a few tenth of a second before the contact of the two components 10, 11 takes place. This is necessary in order to ensure retraction of the induction coil 9 between the components 10, 11 and the subsequent closing of the axial gap to the contact.

In the example of the bringing together of two components 10, 11, which are embodied with clean, smooth, straight-cut parallel ends, the induction coil 9 can be arranged between opposite longitudinal ends of the two components 10 and 11, which leaves a small gap 12 and 13 on each side. The induction coil 9 is normally a coil, which is wound once and is formed of hollow rectangular copper pipe in order to allow cooling water to circulate during the induction-heating cycle.

In the alternative, it is also conceivable to attach the induction heater 40 on the outside, so that it encompasses the opposite surfaces, which are to be welded to one another, or surrounds them in a ring-shaped manner, respectively. The induction coil 9 thereby forms a ring, which surrounds the camshaft 111.

The induction coil 9 is connected to a high frequency power supply either by means of flexible power supply cables or in the alternative by means of rotary or sliding joints. The size of the gap 12 and 13 is normally adjusted to the possible minimum value prior to the beginning of the physical contact and/or prior to the flashover between the induction coil 9 and one of the components 10 and 11, either during the heating phase or during the retraction. If the two components 10 and 11 have the same diameter, wall thickness and metallurgy, the induction coil 9 is arranged at the same distance between the opposite ends of the components 10, 11. In uses, where one or a plurality of these three parameters between the two components 10, 11 of the camshaft 111 are different, the equalization of the heat supply to the two components 10, 11 is attained by moving the induction coil 9 closer to the component 10 or 11, which requires the extra heat supply. It is the primary goal of the gap adjustment to ensure that both components 10, 11 reach their respective hot work temperature at the same time. The gap 12, 13 can either be determined and adjusted prior to the start of the induction heating phase or, in the alternative, continuously during the induction heating by means of a non-contact temperature sensor.

The gaps 12 and 13 serve two purposes. First of all, they avoid physical contact between the induction coils 9 and one of the components 10 and 11, which would lead to a contamination of the component surface and an electrical short-circuit of the induction coil 9. In addition, they represent a path for the flow of a protective gas 14, which avoids an unwanted oxidation of the heated ends of the components 10 and 11. Even though nitrogen is preferred in many uses for the above-specified reason, the protective gas can be nitrogen, carbon dioxide, argon or other non-oxidizing gases or mixtures thereof, chosen according to the metallurgical requirements and availability at the workplace. On the outer side, the gas is surrounded by a flexible curtain 15, which abuts closely around the outer circumference of each component 10, 11, whereby the gas 14 is forced to flow radially inwards and thus continuously displaces any oxygen away from the released component ends. Provision is furthermore made for allowing a retraction of the induction coil 9, while the flexible curtain 15 is held in position.

The selection of a suitable protective gas 14 depends primarily on the metallurgy of the components 10, 11 and on the high temperature ionization properties of the gas 14. Nitrogen is sufficient for most of the uses, which relate to ferrous compounds and nickel-based alloys. For certain metallurgies, however, a different gas may be necessary, e.g. in the case of titanium compounds. Even though it is preferred to use a suitable protective gas 14, it should be recognized that the components 10, 11 can be protected against harmful gases by alternative and additional methods, such as, e.g. precoating. For this purpose, the opposite surfaces of the components 10, 11 can be precoated directly with a protective barrier substance, such as, e.g., a chloride-based flux material, which preferably rules out hydrogen.

FIG. 3 now shows a camshaft 111, which is produced according to the method according to the invention, comprising a drive element and a camshaft tube.

1. A method for producing a camshaft comprising:
providing at least two metallic components; and
welding the at least two components to one another via a combined induction/friction welding method.

2. The method according to claim 1, wherein providing the at least two components includes arranging a drive element as one of the at least two components on a longitudinal end of a camshaft tube as the other of the at least two components.

3. The method according to claim 1, wherein the combined induction/friction welding method includes:
heating opposite surfaces of the at least two components via an induction heater to a predetermined temperature that is greater than a re-crystallization point of the at least two components in a non-oxidizing atmosphere;
continuously moving at least one component relative to the other component of the at least two components parallel to the opposite surfaces;
bringing together the opposite surfaces of the at least two components to be connected to one another with an axial force while at least one of the at least two components is in motion to weld the opposite surfaces of the at least two components to one another, wherein at least approximately 90% of the welding energy is contributed by the induction heater and the equalizing welding energy is contributed by common friction welding, and wherein a loss of total length of the at least two components is less than 1.0 axial millimeters per millimeter of a wall thickness of the at least two components.

4. The method according to claim 3, wherein heating the opposite surfaces of the at least two components to the predetermined temperature is performed in a time of less than approximately 30 seconds.

5. The method according to claim 1, wherein the combined induction/friction welding method welding opposite surfaces of the at least two components to one another in approximately one second after heating the opposite surfaces to a predetermined temperature, and maintaining an axial force of the at least two components held against one another for approximately five seconds.

6. The method according to claim 1, wherein the combined induction/friction welding method includes rotating at least one of the at least two components and welding opposite surfaces of the at least two components to one another in less than approximately four rotations after heating the opposite surfaces to a predetermined temperature, and maintaining an axial force of the at least two components held against one another until a welding temperature falls below the predetermined temperature.

7. The method according to claim 1, wherein the combined induction/friction method includes inductively heating opposite surfaces of the at least two components to a predetermined temperature that is greater than a re-crystallization point of the at least two components in a time of less than approximately ten seconds.

8. Method according to claim 1, wherein the combined induction/friction welding method includes heating opposite surfaces of the at least two components via an induction heater at a frequency of approximately 10 Kilohertz or more.

9. The method according to claim 1, wherein the combined induction/friction welding method overflowing opposite surfaces of the at least two components with a non-oxidizing gas composed of predominantly nitrogen gas while heating the opposite surfaces to a predetermined temperature greater than a re-crystallization point of the at least two components via an induction heater.

10. The method according to claim 1, wherein welding the at least two components to one another includes keeping opposite surfaces of the at least two components substantially in a vacuum atmosphere.

11. The method according to claim 10, wherein welding the at least two components to one another further includes heating the opposite surfaces in a vacuum to a predetermined temperature greater than a re-crystallization point of the at least two components via an induction heater.

12. The method according to claim 1, further comprising precoating opposite surfaces of the at least two components with a metallurgically compatible material and a thickness of less than 0.025 mm after heating the opposite surfaces to a predetermined temperature greater than a re-crystallization point of the at least two components via an induction heater.

13. The method according to claim 1, wherein welding the at least two components to one another includes: continuously moving at least one of the at least two components in a rotational movement.

14. A camshaft, comprising:
a camshaft tube and a drive element, the drive element joined to a longitudinal end of the camshaft tube at a combined induction/friction welded connection.

15. The method according to claim 1, further comprising inductively heating opposite sides of the at least two components to a predetermined temperature that is greater than a re-crystallization point of the at least two components in a time of less than approximately ten seconds before welding the at least two components to one another.

16. The method according to claim 1, further comprising:
inductively heating opposite surfaces of the at least two components to a predetermined temperature greater than a re-crystallization point of the at least two components; and
overflowing opposite surfaces of the at least two components with a non-oxidizing gas while the at least two components are at the predetermined temperature.

17. The method according to claim 16, wherein the non-oxidizing gas is composed of predominately of nitrogen gas.

18. The method according to claim 3, wherein the induction heater is arranged between the opposite surfaces of the at least two components during the heating.

19. The method according to claim 7, wherein the opposite surfaces of the at least two components are parallel to one another.

20. A method of producing a camshaft, comprising:
welding a drive element to a longitudinal end of a camshaft tube via a combined induction/friction welding technique, the combined induction/friction welding technique including inductively heating opposite surfaces of the drive element and the camshaft to a predetermined temperature that is greater than a re-crystallization point of the at least two components at a frequency of approximately 10 Kilohertz or more.
